(19) United States
(12) Patent Application Publication
(10) Pub. No.: US 2014/0172526 A1
(43) Pub. Date: Jun. 19, 2014

(54) Transaction tax collection system and method

(71) Applicants: Miguel Arrocho, San Juan, PR (US); Sergio Perez-Biascochea, San Juan, PR (US); Felix Camacho, San Juan, PR (US); David Arrocho, San Juan, PR (US); David Rivera, San Juan, PR (US)

(72) Inventors: Miguel Arrocho, San Juan, PR (US); Sergio Perez-Biascochea, San Juan, PR (US); Felix Camacho, San Juan, PR (US); David Arrocho, San Juan, PR (US); David Rivera, San Juan, PR (US)

(21) Appl. No.: 13/716,277

(22) Filed: Dec. 17, 2012

(51) Int. Cl. G06Q 30/02

(52) U.S. Cl. CPC G06Q 30/0212
USPC 705/14.14

(57) ABSTRACT

A system and method for sale and use tax collection rate by providing a system and method including a mechanism to incent taxpayers comprising three major components: Merchants (Data Capture devices), Processors/Acquirers and the Aggregator.

### STATEMENT REGARDING FEDERALLY SPONSORED RESEARCH AND DEVELOPMENT

N/A

### RELATED APPLICATIONS

N/A

### BACKGROUND OF THE INVENTION

1. Field of the Invention

The invention relates to data processing systems and the methods of their use. In particular, the invention relates to a system and method to improve sale and use tax collection by providing incentives.

2. Discussion of the Background

Act No. 117 of Jul. 4, 2006 amended the Puerto Rico Internal Revenue code of 1994, as amended, to provide, among other things, for a general sales and use tax of 5.5% imposed by the Commonwealth on the sale of a wide range of goods and delivery of various services. Further, Act 117 also authorized each municipal government to impose a municipal sale and use tax of 1.5%. In general, the municipal sales tax has the same tax base, exemptions (except for non-prepared foods) and limitations as provided for the Commonwealth Sales Tax.

The Commonwealth Sales Tax is imposed on the sale, use, consumption, and storage of taxable items, which include tangible personal property, taxable services, admission rights and certain other types of transactions covering separable and identifiable taxable items which are sold for a single price, subject to certain exceptions and limitations. The Secretary of the Treasury has the authority to establish by regulation the conditions for exemption from the tax. Certain articles and items, including items purchased for resale by merchants, are currently exempted by the Treasury from the tax.

The Commonwealth Sales Tax went into effect on Nov. 15, 2006. Since implemented by the Government of Puerto Rico, total Commonwealth Sales Tax collections have been on average over $90 million per month. In the current collection process, the general guidelines and procedures are as follows:
Merchants and retailers are required to collect the Commonwealth Sales Tax from the consumer; otherwise the consumer is required to pay the tax.
Each merchant and retailer is currently required to file a monthly return detailing all taxable transactions for the prior month no later than the 10^{th} day of each month. Certain large merchants and retailers are required to file their return electronically. Merchants and retailers remit select Municipal and Commonwealth sales and use tax collected during the prior month to several Authorized Collectors designated by the Secretary of the Treasury. Further, the Authorized Collectors are then required to transfer sales and use tax payments to the Treasury and the appropriate Municipalities.

Even when the total Commonwealth Sales Tax collections have been on average over $90 million per month, as mentioned above, this amount only represents approximately between 52% to 65% of the potential sales and use tax revenue. Therefore improving Puerto Rico's sale and use tax collection rate and bringing it up is one of the objectives of the Puerto Rico Department of the Treasury (PRTD). The PRTD is requesting information from potential service providers that can provide a compliance solution to improve the collection rate of the sale and use tax (SUT).

PRDT needs to implement a system that will gather merchants' sales transactions on a daily basis to improve their SUT auditing and reconciliation processes.

Therefore there is a need for a system and method for computing and collecting taxes, more particularly a system and method that properly computes and collects sales and use taxes in compliance with the legal guidelines and restrictions imposed by national governments such as the Puerto Rico.

### SUMMARY OF THE INVENTION

The present invention overcomes the limitations of the Puerto Rico's sale and use tax collection rate by providing a system and method including a mechanism to incent taxpayers comprising three major components: Merchants (Data Capture devices), Processors/Acquirers and the Aggregator.

The Data Capture component gathers all of the BUT amounts included in the sales transactions processed by Merchants. The system and method, as mentioned, also provides a mechanism to incent taxpayers, wherein the incentive comprises a lottery. The lottery is a contest in which particular indicia are distributed or sold, wherein the winning particular indicia is secretly predetermined or ultimately selected in a random drawing. The particular indicia can be a serial of character such as numbers or letter. The lottery for the sale and use tax collection is name IVU Lotto. The Data Capture component also has the logic to print out the lottery numbers, draw number and date in the consumer's receipt.

The Processors/Acquirers component validates the transactions to determine eligibility for the lottery, stores the transactions SUT and lottery information and provides the Aggregator the informative and deposit files.

The Aggregator component receives the informative and detailed deposit files from all of the Processors/Acquirers, to store Merchants SUT sales transaction and provide PRDT audit tracking tools. It also, receives and provides Lottery Vendor's the lottery numbers issued. The Aggregator will provide Merchants, PRDT, Processors/Acquirers, Lottery Vendor and Municipalities a Unified Web Portal to view their corresponding information. Additionally, it will interact with IVR and Mobile technologies to provide several Unified Web Portal services and auditing capabilities. Finally, the Aggregator will generate the unique lottery numbers and provide them to each processor.

Therefore one of the objectives of the present invention is to improve the SUT capture rate in accordance with the principle of the present invention.

Another object of the invention is to eliminate or reduce SUT evasion in accordance with the principle of the present invention.

Another object of the invention is to increase the filing of SUT monthly returns that reflect accurate information in accordance with the principle of the present invention.

Another object of the invention is to make the filing and processing of the SUT monthly return easier for both the taxpayer and the PRTD, respectively in accordance with the principle of the present invention.

Another object of the invention is to allow merchants to make daily deposits of SUT proceeds directly to the PRTD in accordance with the principle of the present invention.

Another object of the invention is to provide a platform that will interact with technology already in place, which is trusted by all types of merchants, both major and of lesser volume (POS).

Another object of the invention is to provide a platform that will interact with other technologies of Data Capture devices such as Fiscal Cash Registers.

Another object of the invention is to facilitate control of tax compliance by creating intelligence with detailed information of the merchant sales among other features.

Another object of the invention is to provide a Web Portal that provides Merchants a mechanism to view their processed transactions along with its lottery number.

Another object of the invention is to provide a Web portal that provides PRDT's authorized personnel tools to execute administrative tasks for the sales and use tax transactions review.

Another object of the invention is to provide PRDT's authorized personnel access to view the SUT amounts captured by each merchant.

Another object of the invention is to provide Merchants the capacity to view the same information as PRDT but only their particular (merchant) information.

Another object of the invention is to provide PRDT effective tools to validate the information on SUT provided by the merchant at the end of each fiscal term, especially for cash and check transactions.

Another object of the invention is to provide capability to view, record, track, and audit SUT transaction information.

Another object of the invention is to provide the Lottery Vendor, PRDT and Merchants access to IVU Lotto information.

Another object of the invention is to provide reporting capabilities for PRDT, Merchants, Municipalities and Processors.

Another object of the invention is to provide PRDT with tools for business activity monitoring and reporting processes.

Another object of the invention is to provide a tool that helps PRDT to analyze the business data, such as merchant sales transactions, adjustments, payments, location, industry type and date, among other critical data elements.

Another object of the invention is to provide a system and a method for performing integrated lottery ticket and merchandise transactions.

Another objective of the invention is to provide a POS terminal designed to performed lottery transactions in addition to merchandise transactions.

The invention itself, both as to its configuration and its mode of operation will be best understood, and additional objects and advantages thereof will become apparent, by the following detailed description of a preferred embodiment taken in conjunction with the accompanying drawing.

The Applicant hereby asserts, that the disclosure of the present application may include more than one invention, and, in the event that there is more than one invention, that these inventions may be patentable and non-obvious one with respect to the other.

Further, the purpose of the accompanying abstract is to enable the U.S. Patent and Trademark Office and the public generally, and especially the scientists, engineers, and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying drawings, which are incorporated herein, constitute part of the specifications and illustrate the preferred embodiment of the invention.

FIG. 1 shows a flow chart presenting the three major components interaction in accordance with the principles of the present invention.

FIG. 2 shows a diagram chart presenting the three major components interaction in accordance with the principles of the present invention.

FIG. 3A through 3D shows an example of the Virtual POS graphical user interfaces (GUI) in accordance with the principles of the present invention.

FIG. 4 shows an example of the fiscal device architecture in accordance with the principles of the present invention.

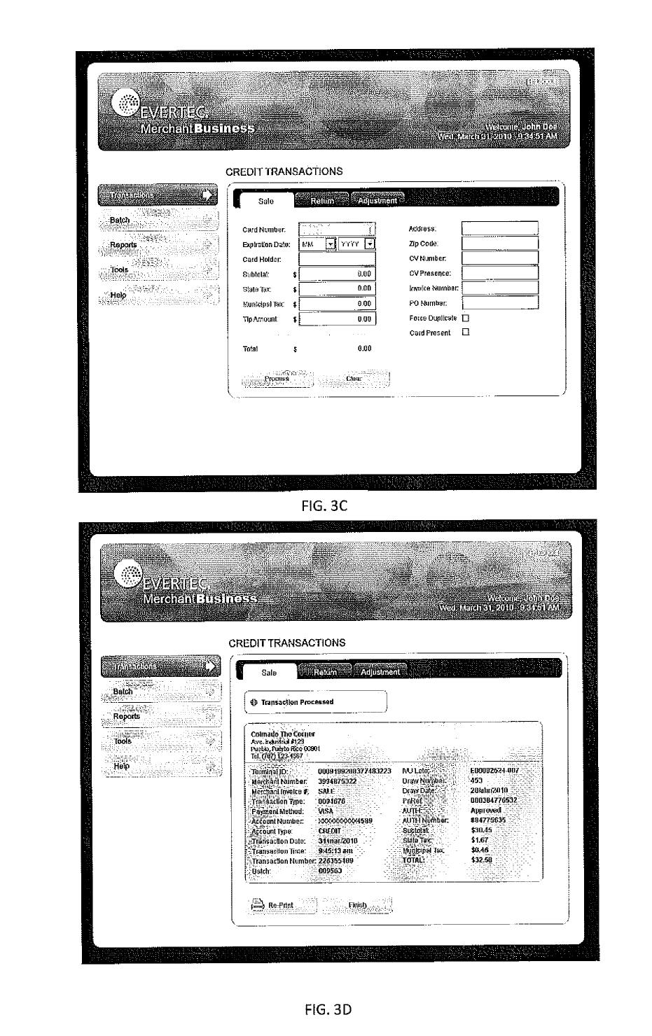

FIG. 5 shows is a graphical representation of the processes executed by the Processors/Acquires in accordance with the principles of the present invention.

FIG. 6A through 6B is a graphical representation of the processes executed by the Aggregator in accordance with the principles of the present invention.

FIG. 7A shows a graphical representation of the Unified Web Portal Architecture in accordance with the principles of the present invention.

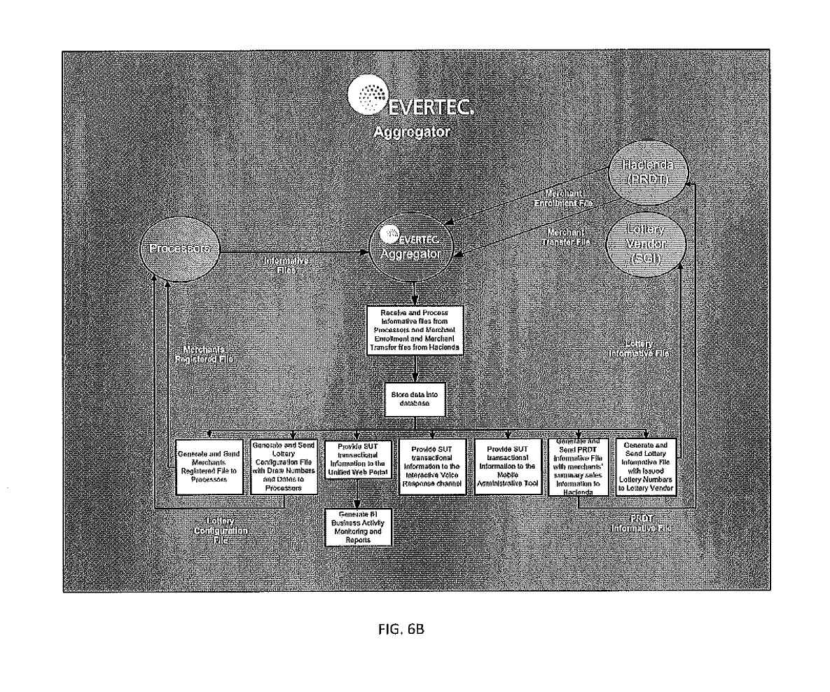

FIG. 8A shows an example of the Unified Web Portal Architecture GUI in accordance with the principles of the present invention.

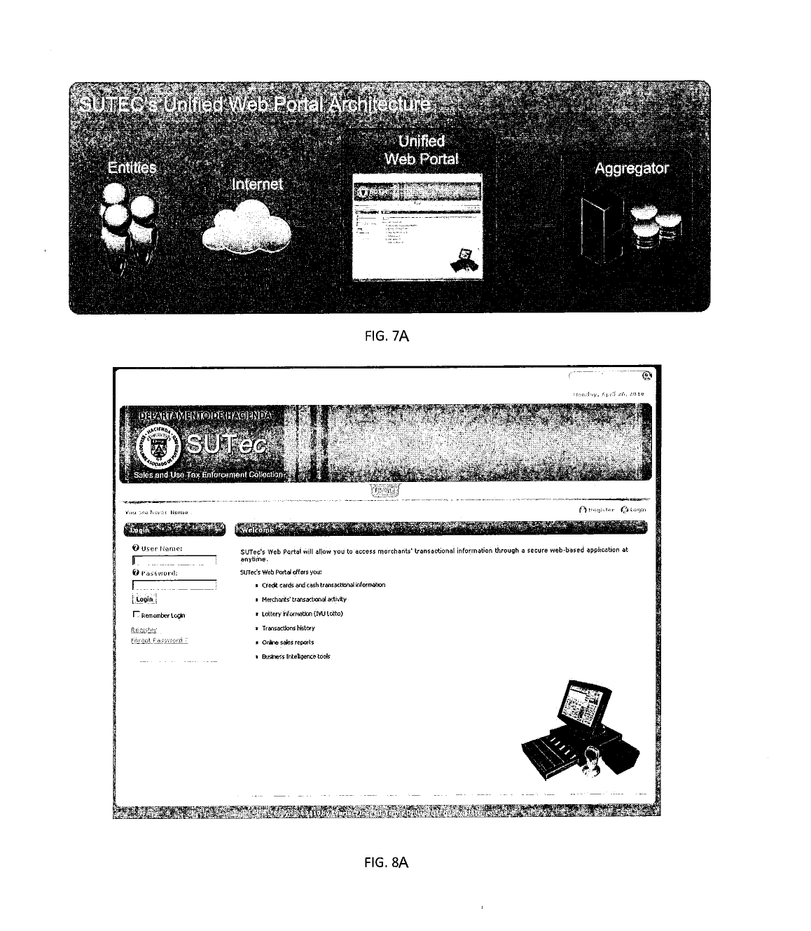

FIG. 9 shows an exemplary diagram of the Business activity and monitor and reporting in accordance with the principles of the present invention.

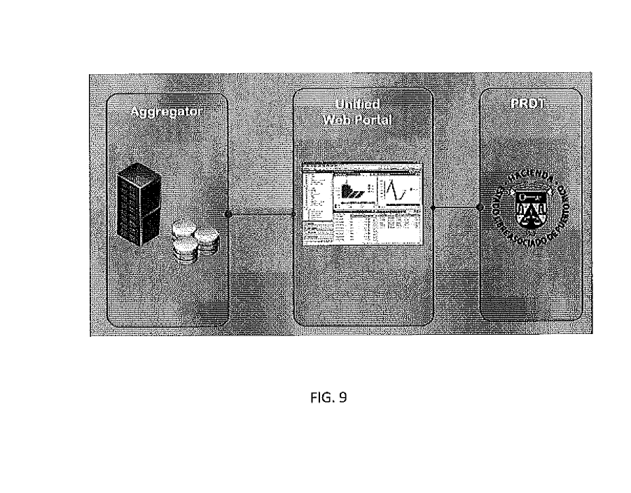

FIG. 10 shows a graphical representation of the IVU Lottery Management process in accordance with the principles of the present invention.

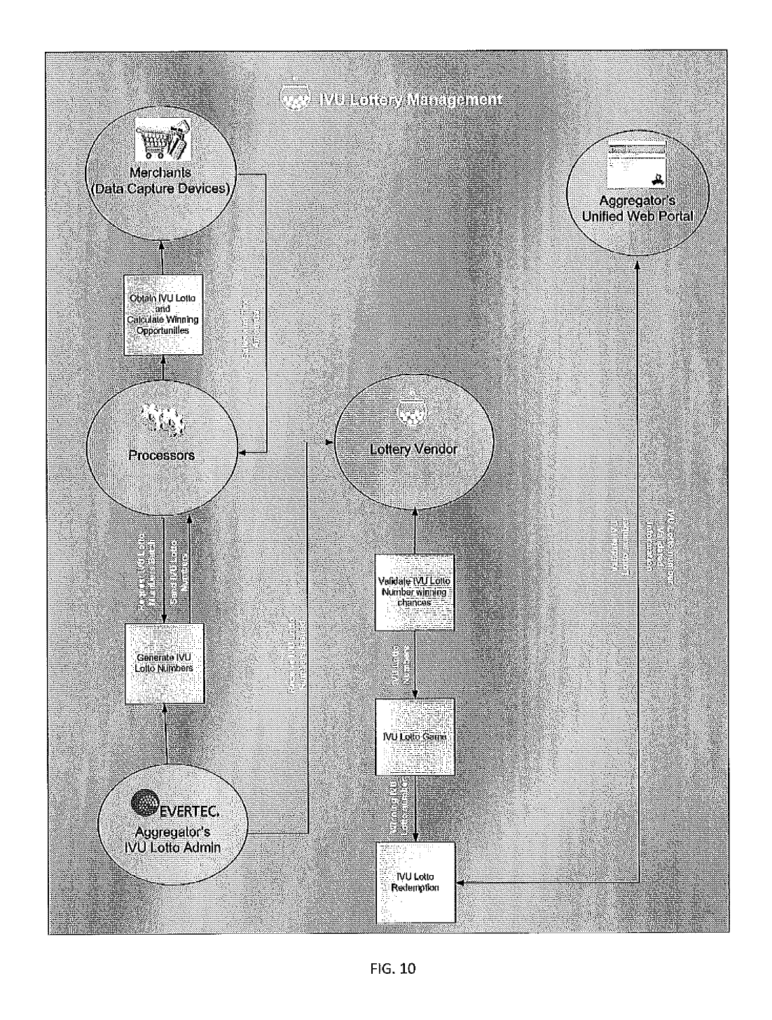

FIG. 11 shows a graphical representation of an example of the IVR service flow in accordance with the principles of the present invention.

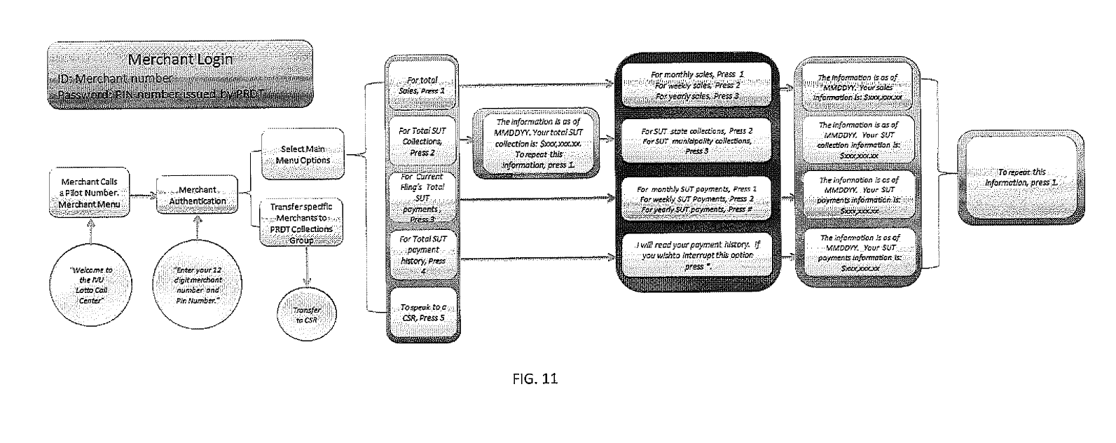

FIG. 12 shows an example of the MAT Tool GUI in accordance with the principles of the present invention.

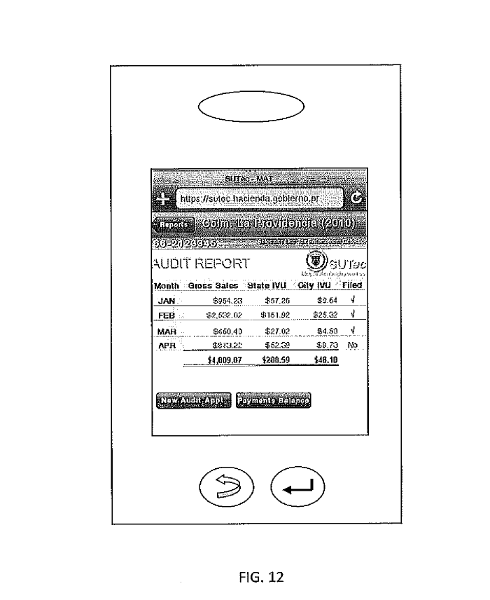

### DESCRIPTION OF THE PREFERRED EMBODIMENT

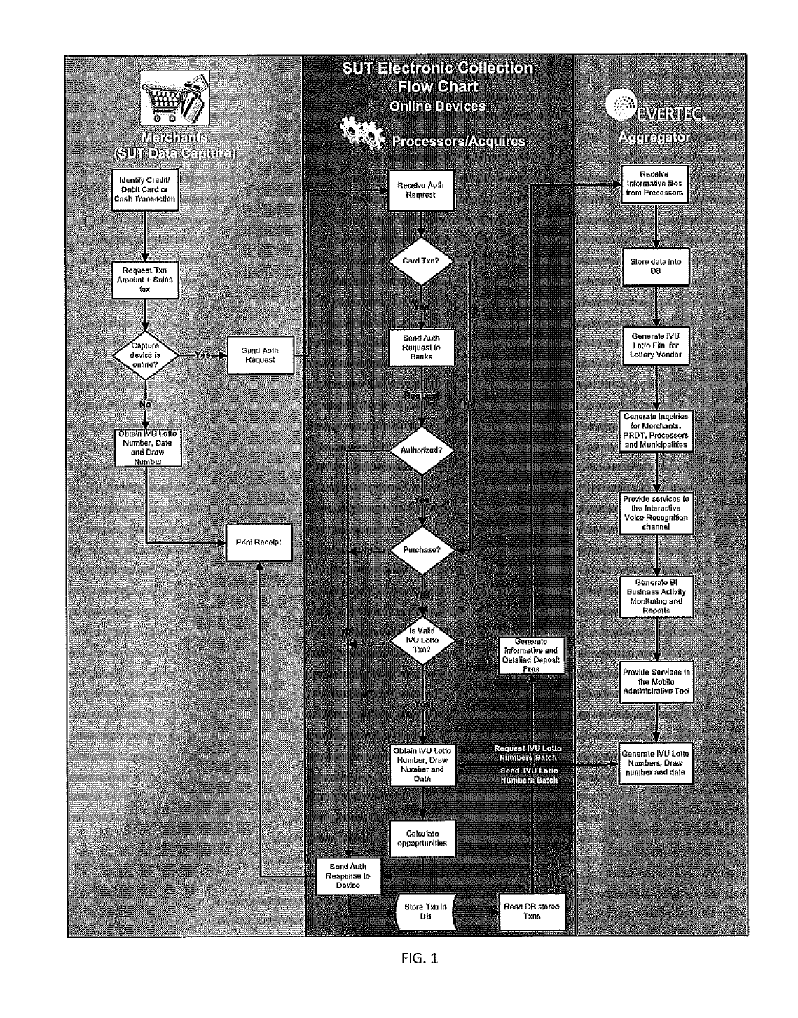

FIG. 1 shows a flow chart presenting the three major components interaction in accordance with the principles of the present invention. The present invention encourages Tax Payers' participation by lottery, known as IVU Lotto. This will give consumers a chance to win a monetary price twice a week. To participate, the customers must request merchants to enter the merchandise transaction in the Data Capture Devices (POS, Fiscal devices, Fiscal Cash Register, Virtual POS and POS Wireless) so an IVU Lotto number will be printed on their receipt. The process is explained in more details below.

The system and method for sale and use tax collection receives two files from each processor and or acquirers; one that will be known as Informative File and will include those transactions captured on a daily basis, the other known as Detailed Deposit file that will include the deposited transactions. The first file will provide PRDT with daily transactional volume and IVU Lotto numbers generated. The detailed deposit file will provide the actual Merchant's SUT collection deposited into their accounts, thus, improving PRDT's capabilities to audit merchants' responsibilities. This file must include the Merchant's bank account number for additional services described below in the Aggregator's section.

PRDT requires having access to a Web Portal, which is explained below, that provides Merchants a mechanism to view their processed transactions along with its IVU Lotto number. The portal must provide PRDT's authorized personnel tools to execute administrative tasks for the sales and use tax transactions review.

The present invention includes other informational channels such as Interactive Voice Response (IVR) services and Mobile Administrative Tools (MAT) with enhanced unified web portal functions. Both functions are explained in more details below.

The IVR channel will provide Merchants without a computer based Internet access an alternative to validate its SUT transaction information.

The Mobile Administrative Tool will provide PRDT's auditing personnel access to Merchants' SUT capture balances, tendencies and generate appointments for follow up auditing tasks.

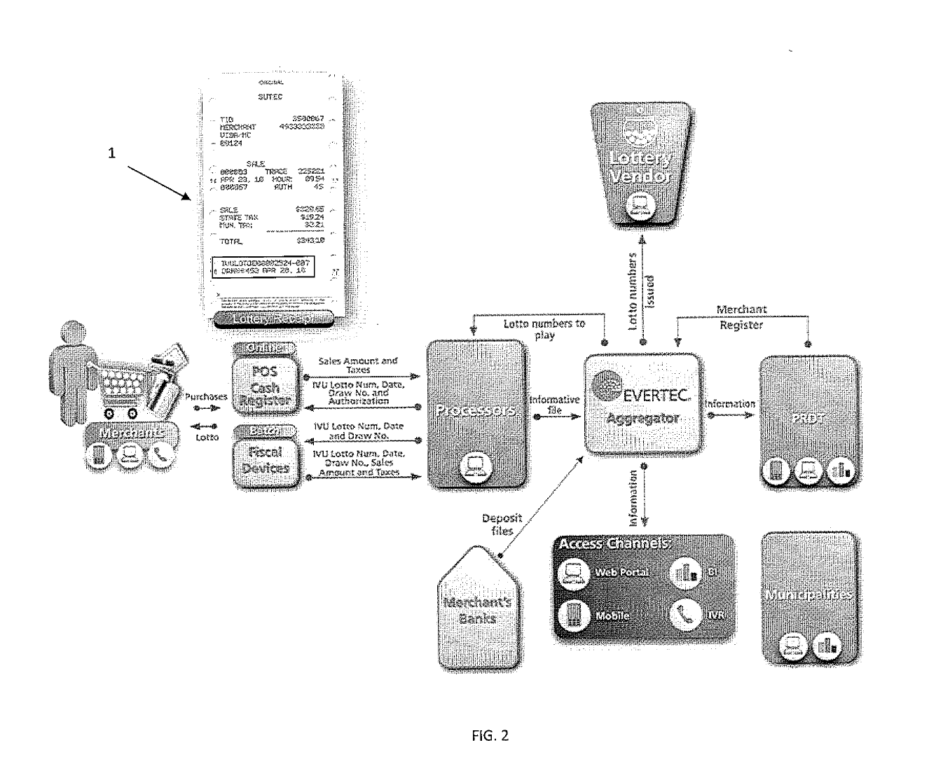

FIG. 2 is a functional and graphical representation of how the present invention captures the fiscal information and additional collections through the use of different data capture devices technologies. It will present how unbanked merchants can be managed using two different technologies (fiscal devices or wireless POS). It also includes how the IVU lottery number will be generated and handled for each merchant type:
A client visits a merchant and purchases several articles.
The transaction must be registered at the data capture device (Regular POS, Virtual POS, Wireless POS, FCR or Fiscal Device). Sale and SUT amounts must be entered separately.
When the Sales and SUT amounts are entered through a POS (regular or wireless) the transactions are handled online, therefore, this information must be transmitted to the processor and to the authorizer to obtain approval for the transaction.
During approval, the processor must include the IVU Lotto number, draw number and date for the IVU Lottery in its online message. The POS will print this data on the receipt.
For cash only merchants when PRDT determines that an offline procedure is the best fit, the present invention provides a secure fiscal device with the capability of being preloaded with valid IVU Lotto numbers; therefore it will not require an online connection for the IVU Lotto generation. This device will also provide the date for the IVU Lottery in its receipt.
Processors/Acquirers will continue depositing into the merchant's account their daily card transactions depending on their settlement process.
In addition to the deposit process, each processor will need to generate two files; one of them contains all of merchant's daily transactions including those in cash and check, we will refer to this file as the Informative file, as mentioned before. The Informative file requires the following fields among others: transaction number, merchant ID, purchase amount, sales tax amount and IVU lottery number and must be sent to the Aggregator on a daily basis. The second file, which we will refer to as the Detailed Deposit file, as mentioned before, must include those transactions that were deposited into the merchant's account. This file requires the information of the actual deposit of the Merchant.
Fiscal devices will only need to generate the Informative file including the fields mentioned above and send it to the Aggregator on a daily basis.
All transactions will be stored in the Aggregator's database.
The Aggregator will provide PRDT business activity monitoring and reporting through its Business Intelligence tools.
The solution described doesn't include a daily SUT remittance, but it will provide PRDT with a built in option to execute SUT remittances to selected merchants on a daily, weekly, monthly or upon request. PRDT will have the tools necessary to determine which merchants have not remitted their SUT obligations in order to make the collection decision.
The present invention submits to PRDT the approval with the Processors/Acquirers specifications and operational procedures, required to support the IVU Lotto project implementation. In order to proceed, Processors/Acquirers will make the necessary enhancements into their POS and/or ECR (Electronic Cash Registers) systems. Once the processors received the information, they should develop their systems enhancement within 90 days, and must inform PRDT their implementation plan with the detailed milestones.
Once the specifications are approved by PRTD, The present invention proceeds with the data capture devices updates. Program updates will be downloaded at the end of the day, once the merchant perform the settlement process. If the update process fails, a physical visit must be scheduled to those merchants where the update was aborted. This function will be performed as stated in the roll out document.
The present invention prepares and submits to PRDT the approval with the Processors/Acquirers specifications and operational procedures, required to support the IVU Lotto project implementation. In order to proceed, Processors/Acquirers will make the necessary enhancements into their POS and/or ECR (Electronic Cash Registers) systems. Once the processors received the information, they should develop their systems enhancement within 90 days, and must inform PRDT their implementation plan with the detailed milestones.
Once the specifications are approved by PRTD, the present invention proceeds with the data capture devices updates. Program updates will be downloaded at the end of the day, once the merchant perform the settlement process. If the update process fails, a physical visit must be scheduled to those merchants where the update was aborted. This function will be performed as stated in the roll out document.

As mentioned, the three major components: Merchants (Data Capture Devices), Processors/Acquirers and the Aggregator are explained in details below.

Data Capture

The main purpose of the Data Capture Device component is to gather PRDT SUT information regarding merchants' transactions and transferring it to the Aggregator. The data capture process requires that Merchants have devices that capture SUT information plus provide the consumer an IVU Lotto number.

The present invention has the capacity to interact with different data capture technologies. As part of the solution we will provide details of the roll-out and maintenance processes for them.

A brief description of the most common data capture devices: Regular POS, Wireless POS, Virtual POS, Fiscal devices and Fiscal Cash Registers is included.

Point of Sales Terminal Solution

Point of Sales (POS) is an electronic device used by Merchants at their point of sales that needs to be programmed by its corresponding processor and/or acquiring bank to capture SUT transactions.

When processing a transaction the merchant is responsible of entering into the POS terminal the SUT transaction information. The POS terminals must be capable of capturing the transaction information, including the sales tax amount and printing the receipt with the IVU Lottery information for sales transactions.

The following are several of the business rules POS terminals and vendors must comply with:
Allow manual entry of state and municipality IVU amounts for the following transactions:
Regular purchases
   Purchases with cashback
   Sales adjustments
   Cash Only
   Reversals
   Refund (does not apply to Cash Only transactions)
   Void (does not apply to Cash Only transactions)
   Mail Orders
   EBT Cash Sale
Include in totals reports all amount corresponding to IVU and cash transactions.
Print IVU Lotto number, winning chances, draw number and date only in the customer copy for thermal printers.
Allow synchronizing and discharging new programs to current merchant.
Distinguish between a cash/check and credit/debit card by providing the merchant with another key entry for cash/check transactions.
Generate a detailed report for refund transactions including SUT state and municipality tax amounts.
For cash transactions, refunds is not recommended
   The use of POS terminals as a data capture device presents the following benefits:
Reduce the investment necessary to implement the IVU Lotto project by using POS technology already in place in over 60% of existing merchants.
Less Merchant training effort since they will be using the same technology as today with new operational procedures.

Wireless POS

As an alternative to manage unbanked cash only merchants, we recommend the use of Wireless POS devices. The equipment's communication is cellular based, therefore, can be used at Merchant's where there is not a LAN or dial up connection.

The following are several of the business rules Wireless POS devices and vendors must comply with:
Capture the total sales amount, municipality and state tax amounts, when purchase and refund transactions occur.
Process cash/check transactions and request the total sales, municipality tax and state tax amounts.
Print out the IVU Lottery number, date and draw number on the customer's receipt.
Generate a detailed report for purchase
For cash transactions, refunds is not recommended
Include in totals reports all amount corresponding to SUT and cash transactions.
   POS wireless terminals present the following benefits:
Can be used for merchants who do not have a LAN or dial up connection.
Battery operated Wireless POS can be used for merchants who are street merchants (peddlers).

Virtual POS

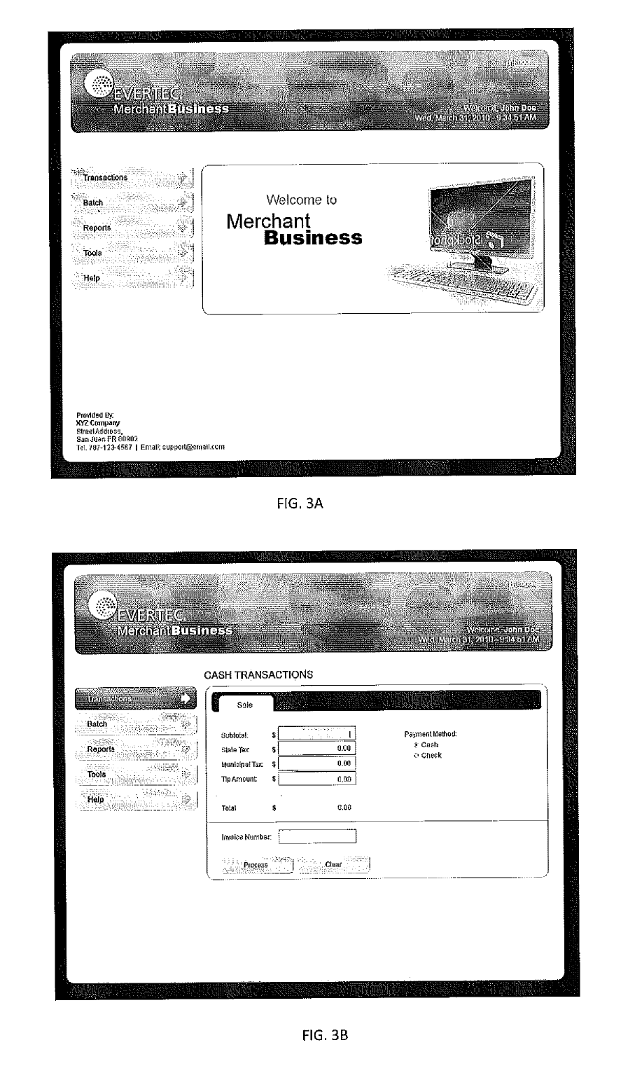

The Virtual Point of Sale (Virtual POS) converts any Internet-connected computer into a point-of-sale (POS) terminal. The Virtual POS is an easy-to-install, easy-to-use, secure, and low-cost solution. It is suitable for merchants of any size and is ideal for kiosks, art galleries, rentals, etc. FIG. 3A through 3D, show several examples of graphic user interfaces in accordance with the principles of the present invention.

This application can be easily downloaded, installed and activated by customers. Local or network printers can be used to print receipts. Optional card swipers and PIN pads can be configured to accept credit or debit card data.
Allow manual entry of state and municipality SUT amounts for the following transactions:
   Regular purchases
   Purchases with cashback
   Sales adjustments
   Cash Only
   Reversals
   Refund (does not apply to Cash Only transactions)
   Void (does not apply to Cash Only transactions)
   Mail Orders
   EBT Cash Sale
Include in totals reports all amount corresponding to SUT and cash transactions.
Print IVU Lotto number, draw number and date only in the customer copy for thermal printers.
Distinguish between a cash/check and credit/debit card by providing the merchant with another function entry for cash/check transactions.
Generate additional report with segregation of SUT tax amounts for refund and purchase transactions.
For cash transactions, refunds is not recommended.

The Virtual POS terminals provide the following benefits:
Sensitive data is stored in EVERTEC's PCI compliant data center, never on client computers. The Virtual POS also keeps an encrypted connection between the computer and the card reader or swiper.
Virtual POS Software can be easily downloaded, installed and activated.
May use local or network printers to print receipts as well as most retail receipt printers.
It can be equipped with optional card swipers and PIN pads to easily accept credit or debit card.
It is PCI Compliant technology.
Only stores the necessary data in the client's computers and not sensitive data.
It keeps an encrypted connection between the computer and the card reader or swiper at merchant cost.
It authorizes credit card transactions as quickly as when using EVERTEC's regular POS terminals.
It accepts the common recognized credit and debit cards such as Visa®, Master Card®, American Express®, and ATH®. It also accepts benefit cards, and cash or check transactions.
Readily accepts data required to send tax records to PRDT and get an IVU Lotto number, date and draw number to be included in printed receipts.
The following are examples of EVERTEC's owned

Virtual POS solution:

Fiscal Devices—SALES Data Controller

The Sales Data Controller is a fiscal device that connects to cash registers secured by a tax stamp. This configuration meets the requirements of fiscal security, controlling the tax information that is printed and record data that are related to what is printed and stored permanently in the fiscal memory. The fiscal memory is the device memory where once you save a data, the same cannot be changed. The information recorded in the fiscal memory may be revised after accounting for the tax entities.

We recommend the use of a fiscal device instead of a fiscal printer for unbanked merchants based on the following facts:
Fiscal printers require the substitution of current equipment. The fiscal device memory is an external controller that can be configured for different types of Cash Registers reducing the investment costs.
It has basically no impact on merchant front desk footprint.
It provides wireless communication to the processor, requiring no need to LAN or dial-up connection.
Fiscal device memory lasts longer than fiscal device printers and requires a minimum maintenance cost.

The following are several of the business rules Fiscal devices and vendors must comply with:
Send SUT sales transactions information to the processor.
Connect to Sam4 and Casio cash registers (not all models) via serial port.
Store and provide IVU Lotto numbers, Lotto dates and draw number.
Encrypt in the fiscal device memory the IVU Lotto numbers, date and draw number.
Accumulate and record the total of daily sales and sales municipality and state tax for each purchase receipt.

Fiscal device terminals as a data capture device present the following benefits:
Ability to connect to any cash register that has a serial port, therefore, it does not require the acquisition of new equipments.
Non-volatile memory can keep data even without power.
Capacity enough to keep data records for prescribed period of time (for example six years).
Data can be overwritten only if older then prescribed period of time (six years).
Data is encrypted; only authorized personnel can decrypt data.
Data is digitally signed and cannot be modified without a trace.
Provides state-of-the art data security for banking industry.
Each event has its own counter which is incremented automatically.
Daily report with internal sum counters (total sale, total refund and SUT amounts).

Fiscal Cash Register (FCR)

Fiscal Cash Register is a device used for calculating and recording sales transactions that prints a receipt for the customer. We recommend the use of a FCR which can be battery operated for unbanked merchant as solution to capture the SUT information. It will also provide an IVU Lottery number on the receipt printed.

This FCR has a GPRS dispositive like one that is used by cellular phones for the exchange of the informative file and the Lotto numbers. FCR is a Cash Register but with Fiscal Memory. Fiscal Memory is a special Read Only Memory built into the cash register to store tax information at the time of sale.

The following are several of the business rules Fiscal Cash Register devices must comply with:
Capture the total sales amount, municipality and state tax amounts, when purchase and refunds transactions occur.
Process cash/check transactions and request the total sales, municipality tax and state tax amounts.
Print out the IVU Lottery number, date and draw number on the customer's receipt.
Generate a detailed report for purchase and refund transactions.
Include in totals reports all amount corresponding to SUT and cash transactions.

FCR terminals as a data capture device present the following benefits:
It provides a dual purpose device to cash only merchants; it serves as a fiscal device as well as a cash register.
Can be used as stand alone or configured into a network.
Have special security features e.g. seal, memory, serial no., special technical specifications.

Further, the present invention provides remote and on-site processes for maintenance and upgrade services.

The remote upgrade will be executed using command schedules that include tools to monitor progress and results.

On-site upgrades require personnel that will download and update programs or replace existing equipment. The designated resource validates that the process was completed successfully.

Processors/Acquires

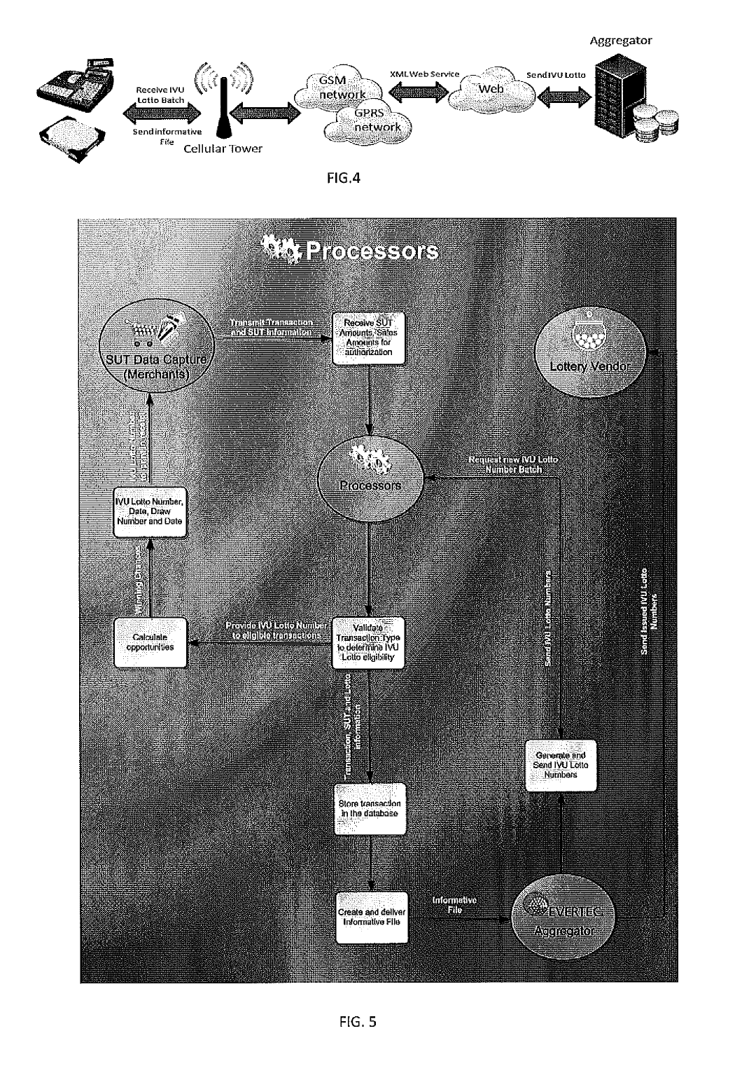

The main purpose of the Processors component in the present invention is to gather, process, store and transmit BUT transactional information plus IVU Lotto numbers received from the data capture devices. FIG. 5 shows is a graphical representation of the processes executed by the Processors/Acquires in accordance with the principles of the present invention.

When an authorized purchase transaction is received via a data capture device, the processors must validate the transaction is eligibility for the IVU Lottery.

If a transaction is eligible for the IVU Lottery, the processor will evaluate the total sales amount to establish the number of chances to win and generates the IVU Lotto Number provided and printed on the consumers' receipt. If the transaction is not eligible, the consumer receipt must include a message indicating that it is not eligible for the IVU Lottery game.

Processors will obtain the IVU Lotto numbers by establishing an interface with the Aggregator where they will receive the IVU Lotto numbers, date, and draw number for a specific period of time, we recommend a month. The Aggregator will be responsible for generating all of the IVU Lotto numbers based on its algorithm and provide them to each processor, this way it increments the uniqueness of the IVU Lotto numbers issued.

When the processors identify that they have reached a 70% of IVU Lotto numbers consumption they must request the Aggregator a new batch of numbers from the current month.

To be able to have a winner in each IVU Lotto game, the Processors must send the Aggregator an informative file that will include the SUT amounts, total sales amount and IVU Lotto number along with other informational fields captured during a sales transaction. In the instant case the informative file is transmitted to the Aggregator at least 18 hours before the day the IVU Lotto game is played. For example, if the IVU Lotto will be on Thursday, every Processor is responsible for submitting their Informative File on Tuesday at 11:59 P.M. Based on this example, the IVU Lotto numbers issued from Wednesday 12:00 AM must be for the following IVU Lotto game date.

When a processor/acquirer deposits into a Merchant's account and it's credited, it must send the Aggregator a detailed deposit file that included the processed transactions.

The following are several of the business rules Processors must comply with:
Receive the total sales amount and sales tax amount from the POS device for purchase and refund transactions.
Process cash and check transactions and maintain them in their log file as authorized transactions.
Receive an IVU Lotto batch number from the Aggregator.
Establish an automatic mechanism to detect when the IVU Lotto numbers issued have reached a 70% and request the Aggregator a new IVU Lotto number batch.
Provide an IVU lottery number, draw number and IVU Lotto date and send it as part of the response message to the authorization request.
In order to use the Aggregator's services, the processors must comply with the processor's certification process.
The Aggregator will assign each processor a unique ID; this ID must be included in all of the files exchanged between both components.
Merchant Registration Number or ID included in the files exchanged between the Aggregator and Processors must be the same as the number assigned by PRDT.
Generate an informative file that will include the following fields: transaction ID, merchant ID, transaction date, transaction type (debit/credit card/cash), sales amount, state IVU amount, municipal IVU amount, IVU lottery number, IVU lottery date, IVU Lottery draw number, among others for each transaction processed by a Merchant and transmit it to the Aggregator.
If the Processor is responsible for depositing into the Merchant's account the final transactions actually deposited, it must generate and transmit to the Aggregator a detailed deposit file including the same fields as the informative file plus add the Merchant's account number.

Aggregator

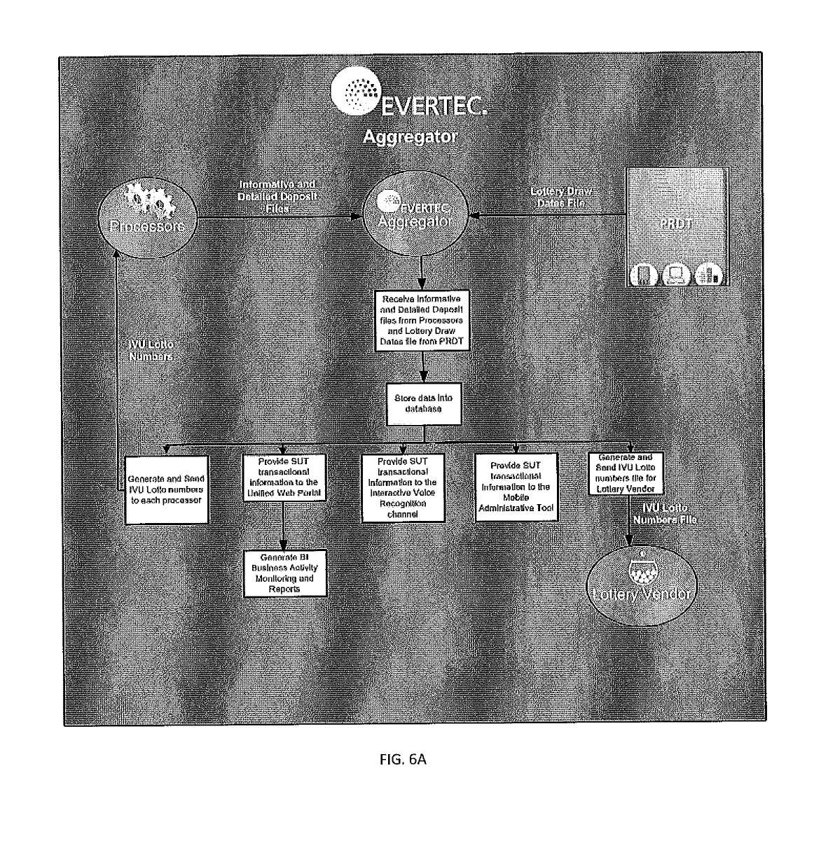

The Aggregator component will provide PRDT with the SUT transactional information of all the merchants. PRDT will have the mechanism to validate SUT information provided by merchants and verify their daily SUT transaction activity. Therefore, the Aggregator will be the main repository of transactional activity of all merchants. FIG. 6A through 6B, show a graphical representation of the processes executed by the Aggregator.

The Aggregator will offer the following capabilities and benefits:
Receive and process the Informative and the Detailed Deposit files from all processors on a daily basis.
Store and consolidate all merchants' SUT transactional information in the database.
Receive and process the file of the lottery draw dates from IVU Lottery Vendor.
Store the IVU Lottery numbers, lottery draw dates and draw numbers in the database.
Aggregate the IVU Lottery numbers generated from each transaction into a file and send it to the Lottery Vendor.
Generate the IVU Lotto numbers and provide them to each processor.
Store the information of all registered merchants and certified processors in the database.
Provide SUT transaction information to the Unified Web Portal reporting tool to view the detail of all merchants' daily transactions.
Provide SUT transactional information to Business Intelligence tools to view and monitor merchants' SUT transaction activity.
Provide SUT transaction information to the Interactive Voice Recognition (IVR) and Mobile Administrative Tool channels.
Provide the capability to store, track, and audit all merchants' SUT transaction information.
Provide Sales and Use Tax tracking.
   To audit all merchants' daily SUT transaction information
   To monitor the status of the files activities
Send alerts and notifications of files that were received, processed, sent, and had errors.
Encrypt and store securely the data in the database.
Comply with the industry data security standard of PCI-DSS.

The Aggregator component will receive two files from all processors with the transactional information plus IVU Lottery numbers issued. Transactional information will be stored in the Aggregator's database that will be available through restricted views on the Unified Web Portal for: merchants, PRDT, processors, and municipalities. In addition, it will provide business activity monitoring and reporting using its Business Intelligence tools.

The Aggregator will store all merchants' sales detailed information based on the Informative and Detailed Deposit files received from all processors. The Informative file will include the detail of all transactions processed by the merchants including the IVU lottery information (IVU Lottery number, date, draw number). The Detailed Deposit file will include all merchant's deposited transactions. These files must include the following fields: transaction identification, merchant identification, transaction date, transaction type (debit/credit card/cash), sales amount, state IVU amount, municipality IVU amount, IVU lottery number, IVU lottery date, IVU lottery draw number, among others.

The present invention, as mentioned, includes developing, implementing and hosting a Web Based Portal to view all transactions processed via the Data Capture Devices (POS, Fiscal devices, FCR, Virtual POS and POS Wireless).

The Unified Web Portal's strategy is to provide a unique platform that enables PRDT, merchants, municipalities, processors, and the Lottery Vendor view the information through the Internet and other channels for all transactions related with the SUT collections.

The Unified Web Portal will offer the following benefits:
Merchants SUT transactional Information can be accessed anytime, anywhere.
A consistent look and feel.
Information and user preferences are stored centrally
Provide the capability to view, record, track, and audit all SUT transaction information.
Provide detailed information on the capture, storage, exchange and audit of merchants' transaction information.
Verify merchants' SUT Transaction activity.
View IVU Lottery information (IVU lottery numbers and date).
Provide reporting capabilities for PRDT, merchants, municipalities, processors, and the Lottery Vendor.
Provide business activity monitoring and reporting through Business Intelligence tools.
Retrieve and print up the reports of SUT transaction information.
Provide an electronic audit trail for sales processed by the merchants.
Provide SUT transaction history.
Manage for appropriate security, segregation, and grant access to particular users.

The Unified Web Portal will upload SUT transaction information which will be accessed by PRDT, merchants, municipalities, processors, Lottery Vendor, and the Program Manager with their corresponding security access.

This alternative will provide the following benefits:
PRDT will have access to view the SUT amounts transferred by each merchant for their transactions.
Merchants will have the capacity to view the same information as PRDT but only their particular (merchant) information.
PRDT will have a mechanism to validate SUT information provided by the merchant at the end of each fiscal term, especially for cash/check transactions.
Processors will have access to view their files activity.
Municipalities will have access to view the SUT information related to the merchants of their municipality.
The Lottery vendor will have access to view the lottery numbers issued.
PRDT will have a mechanism to create and manage the user accounts for the different entities.

Further the Unified Web Portal will provide reports which will be accessed by PRDT, merchants, municipalities, processors, Lottery Vendor, and the Program Manager with predefined viewing privileges and related security.

The Unified Web Portal will provide the following reporting capabilities:
View the SUT related information instantly including the IVU Lottery information.
Search/filter by different criteria.
Print reports.
Download reports in MS Excel (.xls), Acrobat Reader (.pdf), and comma-separated values (.csv) formats.

The Unified Web Portal will generate reports for each entity. The following is a description of the reports provided by the present invention divided by PRDT, Merchants, Processors, Municipalities, and the Lottery Vendor:

PRDT will have the facility to view reports that present the following information:
SUT transactions detailed by merchant—Shows details of all debit/credit cards and cash/check transactions processed by the merchants including the IVU Lottery information (IVU Lottery number and date). This report provides PRDT with the capability to verify the merchants' SUT transaction activity.
Payments by channel—Includes merchants' SUT transaction information by channel (POS, Fiscal Devices, Virtual POS, and FCR, among others). This report contains the detail of all debit/credit cards and cash/check transactions processed.
Industry collection—Includes the recollection done by industries. This report helps PRDT to obtain different tendencies about certain industries.

Merchants will have the facility to view reports that will present the following information:
Processed Sales and the IVU collected during the month—Presents the SUT transaction information of the merchant including the IVU Lottery information (IVU Lottery number and date). This report contains the detail of all debit/credit cards and cash/check transactions processed by the merchant including the IVU Lottery information.
Processed Sales—Presents the SUT transaction information of the merchant. This report includes the detail of all debit/credit cards, cash/check transactions, and refunds processed by the merchant. This report helps the merchant to filing the monthly tax return easily because it contains the following data: total of sales, amount of cash transactions, amount of debit/credit cards transactions, amount of state IVU, amount of municipal IVU, total of refunds, and total of credits.
Municipalities
Sales processed and the IVU collected by municipality's merchants—Presents the SUT transactions information by the municipalities' merchants. This report helps to the municipalities and PRDT to obtain sales statistical data about the merchants.
Processors
Files activity—The objective of this report is to view the activity log of the SUT transaction files received by the Program Manager from such processor. This report helps processors, PRDT and the Program Manager for tracking the status of files activities in the Aggregator.
Lottery Vendor
Lottery numbers issued—The objective of this report is to present the list of the lottery numbers that were issued. This report helps the Lottery Vendor to validate that the lottery numbers are valid to the current draw. This report also helps to avoid fraud and help in the audit process. In addition, the lottery numbers issued will be sent in a file towards the Lottery Vendor.
Other Reports:
Audit Trail—The present invention provides the capability to view, track and audit on a daily basis all SUT transaction information. The Aggregator's audit trail will have all the data elements for the sales transactions including the state and municipal IVU amounts. Further the present invention has the ability to identify the sales transactions by a unique transaction number provided by the SUT data capture devices. This report provides the capability to search/filter by the following selection criteria: transaction identification, transaction date, and file identification. The objective of this report is to help PRDT, processors and/or the Program Manager to easily identify the merchant's sales transactions because it contains the following data: transaction identification, transaction date, transaction type (debit/credit card/cash), sales amount, state IVU amount, municipal IVU amount, processor identification, file identification, and merchant identification.
Files monitoring—The objective of this report is to present the information of the files processing. This report contains the information of the files that were received, processed, sent, and had errors.
Unregistered processors—Monitoring report of processors that are not registered in the system. The objective of this report is to present the information of the processors that are not registered in the system.
Rejected transactions—The objective of this report is to present the information of the transactions that were rejected.
POS/Fiscal Devices inventory—The objective of this report is to present the information of the POS/Fiscal devices. This report helps to have an inventory of all the POS/Fiscal Devices equipment.
Merchants where no activity has been generated from the POS Cash Only—The objective of this report is to present the information of the merchants where no activity has been detected from the POS Cash only.
Merchants that are not properly registered in PRDT—This report contains the information of the merchants that are not properly registered in PRDT.

The present invention include developing and implementing Business Intelligence that provide PRDT the ability to monitor business activity and reporting for all transactions related to the IVU collection and retrieval from the merchants.

Business Intelligence (BI) is a set of strategies and tools focused on administration and knowledge creation through the analysis of an organization's existing data. Business Intelligence Information Systems provide an insight that enhances the organization's competitive advantage among other companies. BI tools have a list of functions as reporting, online analytical processing, analytics, data mining, business performance management, benchmarking and predictive analytics.

The most common characteristics of this methodology and tools are the following:
Information accessibility—Data captured is the main element of this concept. Therefore, this type of tool must provide access to all users to the data with their corresponding dependencies and precedence.
Decision Support—Quicker, fact-based business decision making. This tool permits users to select and manipulate only the data they wish to access.
End User Oriented—Allows end users to use these tools regardless of technical know-how.

The world today is characterized by highly competitive and fast evolution; therefore, it is necessary for the government to have the capacity to recognize and respond rapidly and precisely to constant changes.

Success requires the agility and capacity to anticipate emergent tendencies and opportunities. This makes it possible to immediately transform the strategy and internal processes of the organization to focus its resources on maximizing new opportunities as they arise.

This agility is also based on Business Intelligence, which is the capacity to take the data that each organization obtains on a daily basis and transform it into, information that will permit the organization to make decisions. The key elements of this strategy are the infrastructure and applications that provide the right information to an organization's strategic personnel—at the precise moment—to make possible analysis and fast action based on informed conclusions.

BI improves the agility of the organization, because it offers to strategic groups inside and outside of the organization a specific point of view of the data required for success.

The BI tools will help PRDT to analyze the business data, such as merchant sales transactions, adjustments, payments, location, industry type and date, among other critical data elements. BI will help PRDT to establish the basis for enforcement of SUT collections since it will provide reports that will make it possible to compare tax filing for each merchant versus actual merchant transactions.

The present invention provides PRDT with Business Intelligence tools that will have the capability to generate the following reports:
Merchants' SUT Transaction activity reflecting those Merchants that do not send any SUT transactions during a month.
Compare the SUT Transaction received as of the end of the month for each Merchant against the information included in the monthly tax return.
Compare sales processed by the Merchant against its industry peers as defined by SIC code provided by PRDT.

BI can also compare the SUT collections by each municipality and generate reports for each payment channel, deposits to each municipality, and recollection by industries among others.

Since BI will offer the necessary tools to create an exact image of merchants, tax payers and internal processes, it will represent an essential operational benefit to PRDT.

For security purposes during the sign-on to the

Unified Web Portal, the information is sent encrypted via SSL (Secure Socket Layer). This encryption technology (SSL) uses public keys to encrypt communications between an SSL capable browser and our web site. Communications between the web server and the web browser are encrypted to prevent interception of private data.

The system will grant access only to authorized users to appropriate services according to their security access established by PRDT/Program Manager.

Further the present invention has advanced backup systems that ensure that the information is stored securely. If the user changes their password or connection parameters, our system will send the user an e-mail alerting of the change.

As an additional security measure and to prevent unauthorized access to the accounts, the Unified Web Portal sessions expire after 30 minutes of inactivity.

The present invention complies with the industry data security standard of PCI-DSS. The present invention meets with all of the requirements that PCI needs to be certified.

A list of the main requirements implemented in all PCI applications, are the following:
Build and maintain a secure network.
Install and maintain a firewall configuration to protect cardholder data.
Do not use vendor-supplied defaults for system passwords and other security parameters.
Protect cardholder data.
Protect stored cardholder data.
Encrypt transmission of cardholder data across open, public networks.
Maintain a Vulnerability Management Program.
Use and regularly update anti-virus software.
Develop and maintain secure systems and applications.
Implement strong access control measures.
Restrict access to cardholder data by business need-to-know.
Assign a unique ID to each person with computer access.
Restrict physical access to cardholder data.
Regularly monitor and test networks.
Track and monitor all access to network resources and cardholder data.
Test security systems and processes.
Maintain an information security policy.
Maintain a policy that addresses information security.

The Aggregator will be responsible for generating all the IVU Lotto numbers based on the algorithm designed along the appointed Lottery Vendor and distribute these numbers to the certified processors, the objective is to assure the uniqueness of the IVU Lotto numbers per drawing. Also, the Aggregator consolidates all IVU Lotto numbers generated by the processors and remits a consolidated file to the Lottery Vendor.

The solution includes a module to provide information about suspicious transactions generated at a merchant's location. This module provides reports that identify the following behaviors:
Multiples transactions made in less than 1 minute (same POS, similar amounts, same merchant).
Excess number of refunds per merchant (to detect “ghost” sales transactions to obtain IVU Lotto participations).

A full reconciliation is also made with all transactions in the informative files received or processed by all processors. Each day a file containing all merchants' sales activity is sent to the Aggregator. Each transaction in the Informative file is stored and identified with the file ID to obtain a tracking of the transaction in case of any claims. In case of claims the PRDT/Program Manager operational personnel will have access to view the transaction using a transaction ID or File ID.

The following functionality is obtained with the reconciliation process:
Provide the capability to view, track and audit on a daily basis all SUT transaction information.
Provide all the data elements for the sales transactions.
Provide ability to identify the sales transactions by a unique transaction number.
Provide the capability to search/filter in the reports by the following selection criteria: transaction identification, transaction date, and file identification.

To maintain control over the processors and/or equipment that will connect or send files to the Aggregator it is necessary to establish a series of steps that provide stability to the system. This process is called the Participant Acceptance Testing System (PATS). The PATS process has seven (7) steps exposed below:
1. Register as a Third Party Software with PRTD to the intent of processing IVU Lotto compliance transactions
2. Obtain from the certification authority agent (i.e. the Program Manager) the requirements documentation
3. Develop software consistent with requirements
4. Test software
5. Schedule certification window with the certification authority
6. Certify the software
7. Receive notification of acceptance or report with deficiencies

Third party certification is divided into two categories: Informative file transmission and Fiscal Devices software. Both of these are developed by third party vendors. Third party vendors have the ability to create in-house or commercial applications to submit the informative file and obtain the Lottery numbers from the Aggregator.

Transmission software certification is not based on the acceptance of the filing, but rather the communication via the web service/FTP. Successful transmission requires proper creation of message headers/footers and complies with the entire transmission rules. PATS testing for transmission software include installing the software on a test machine and processing all PATS test cases via the vendor's transmission software from the vendor's site. The transmission software functionality included in PATS testing includes:
1. Validation of the schema of request messages
2. Checks for viruses in binary attachments
3. Documented host requirements
4. Processing of transmission status requests
5. Submission of status requests
6. Receipt of responses and fault messages
7. Invalid FileID and/or ProcessorID to test the fault message handling within the transmission software

Software will be certified once the third party vendor successfully processes all PATS test cases, including the required batches and transmission, through the PATS facility. Once certified, the software will be authorized to submit/get files to the Aggregator production environment. Notification of certification is provided via Aggregator using and official notification. In addition, an email confirmation will be sent to the vendor. Credentials for using the Aggregator are applied to a software package, not the company. Software must be certified whenever changes are made with the latest rules versions. A new Transmission ID will be issued for each new certification. Software must be tested using the PATS facility and certified transmission software.

As part of the IVU Lottery Management we propose that the IVU Lotto vendor generates the IVU Lotto Number and its corresponding IVU Lotto Draw Number and Date. It will be responsible for providing each Processor the IVU Lotto information on a monthly basis or upon request.

The IVU Lottery vendor will receive from the Aggregator a consolidated file with the entire IVU Lotto numbers issued and sales amount to include them as part of the corresponding IVU Lotto game.

The proposed strategy to minimize splitting the purchases in several transactions with the intention to increment the consumers' chances to win is to assign an IVU Lotto participation based on the sales amount. At the moment that the processor prints the IVU Lotto, it will attach a suffix to the number that represents the number of chances that this particular IVU Lotto will have in the drawing. For example, if PRDT decides that every $50.00 of purchase value will have one (1) participation, then when a purchase is: $343.10, the number of chances is seven (7).

The present invention provides the Lottery Vendor access to an IVU Lotto number validation tool in the Unified Web Portal. With this tool the Lottery Vendor personnel will be able to verify that the number was issued and if it has a refund transaction associated.

The following are the business rules each entity must comply for the IVU Lotto Management components:
The Lottery Vendor must establish the algorithm to generate the IVU Lotto number.
The Aggregator must generate the IVU Lotto number and provide them to the processors.
The Lottery Vendor must provide a mechanism to receive the issued IVU Lotto number file from the Aggregator.
The Aggregator must provide a mechanism for the processors to obtain the IVU Lotto numbers.

The processors must include logic to provide an incremental chance to win the IVU Lotto prize to consumers based on the purchase sales amount.

The present invention provides the capability to view, track and audit on a daily basis all merchants' SUT transaction information. The Aggregator will provide PRDT with the mechanism to track and audit all merchants' daily sales transactions. The Aggregator's audit trail will have the detailed information for each sales transaction. Aggregator will have the ability to identify each SUT transaction by a unique transaction number. The detailed description of the audit trail report is included in the Unified Web Portal section.

In addition, the present invention provides the capability to track and audit on a daily basis all transaction files that are sent from the processors to the Aggregator. The Aggregator will have the ability to identify the files by a unique file number provided by the processor. This number will be unique by processor and the nomenclature of how to generate this number will be provided to the processor in the certification process. This module will provide the capability to search/filter by file identification. The objective of this module is to assist PRDT, processors and/or the Program Manager to identify easily the files that are sent to the Aggregator. The detailed description of the files monitoring report is included in the Unified Web Portal section.

The Sales and SUT Tracking and Reporting module will provide the following advantages:
Track and audit all merchants' daily SUT transaction information
Real-time files monitoring
Provide audit trail and file monitoring reports
File integrity
Manage sales transactions
File management statistics
Send alerts and notifications of files activities
Maintain control from submission to file processing
Reduce problem diagnosis and resolution time

The present invention include other informational channels such as Interactive Voice Response (IVR) services and Mobile Administrative Tools (MAT) with enhanced unified web portal functions as an improvement to PRDT's envisioned solution.

The IVR channel will provide Merchants an alternate channel to validate its SUT transaction information.

The Mobile Administrative Tool will provide PRDT's auditing personnel access to Merchants' SUT capture balances, tendencies and generate appointments for follow up auditing tasks.

We will also provide Merchants with a MAT version of the Unified Web Portal that includes balances for sales transactions processed and SUT payments.

Interactive Voice Response (IVR) is a technology that allows a computer to detect keypad inputs over the phone. IVR systems respond with pre-recorded or dynamically generated audio to direct users on how to proceed. IVR systems can be used to control almost any function where the interface can be broken down into a series of simple menu choices. IVR systems are typically used to service high call volumes, reduce cost and improve or empower the caller experience.

The following are the services provided in IVR process:
Telephone self-service tool to validate their sales information and SUTs payments
Merchant total sales by week, month and year
Merchant total SUT Collections and the ability to segregate by:
   Municipality collections
   State collections
Merchant SUT payments by week, month and year based on current filing process
Merchant SUT payments history up to six years. Provide option to determine date range
Transfer the call to PRDT's collection group when a Merchant is identified by PRDT for this feature. We will provide a parameter in the Merchant Registration and Update process thus PRDT determines which Merchants will be available for this feature.
Merchants will be automatically enrolled in this service during the Merchant Registration process.
For login purposes we will use the following identifications:
ID: Merchant Number (Número Registro de Comerciante)
Password: PIN number issued by PRDT

The following is a graphical representation of an example of the IVR service flow:

Further one of the greatest challenges that PRDT has is to efficiently execute field audits and visits to merchants. The present invention proposes to exploit the capabilities of smart phones (e.g. iPhone) as a mechanism to provide field auditors with a tool that would facilitate them to determine if a particular merchant is a candidate to an in-detail audit.

This tool, named Mobile Administrative Tool (MAT), will provide PRDT's auditing personnel access to Merchants' SUT captured balances, filing behavior and to generate appointments for follow up auditing tasks. This feature helps PRDT to gain access to the merchant information anytime, anywhere.

The advantages of this technology are to assist the PRDT to get informative and/or statistical data from merchants, making PRDT auditors work easier. Another potential user is the merchant itself, where it can access information relevant to their sales to help them fill out the weekly tax return.

The MAT tools will provide the following services to PRDT and Merchants:

This module is used by PRDT auditors to evaluate the merchant sales tendencies. PRDT services are the following:
Search merchant information by tax identification number.
View merchant's monthly tax returns.
View Merchant's sales. This report will show total gross sales, state SUT amount, municipal SUT amount, adjustments, and returns.
View a list of the months in which the merchant did not file returns.
View a list of merchants payment balance.
Send follow-up appointments to merchants.

Services provided to merchants are the following:
Gross sales amount
Sales subject to SUT
   State SUT
   Municipal SUT
SUT Payment history
Monthly SUT tax return history

The invention is not limited to the precise configuration described above. While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patently distinguish any amended claims from any applied prior art.

1. A mechanism to incent taxpayers comprising:
a merchant comprising at least a point of sale and means for data capture;
a transactional information generated at the point of sale comprising a merchandise transaction and a fractional value, wherein said transactional information stored at the means for data capture;
a processors/acquirers comprising control means for processing, storing and transmitting said transactional information and verifying said transactional information eligibility; and
an aggregator comprising a first generation means for creating an incentive indicia.

2. The mechanism to incent taxpayers of claim 1, comprising informational channels means to review processed transactions.

3. The mechanism to incent taxpayers of claim 2, wherein the informational channels means to review processed transactions is selected from a web portal, an interactive voice response service or mobile administrative tool.

4. The mechanism to incent taxpayers of claim 1, wherein the first generation means comprises programmable device to carry out a sequence of instructions.

5. The mechanism to incent taxpayers of claim 1, wherein the incentive indicia comprises unique indicia including lottery characters.

6. The mechanism to incent taxpayers of claim 1, comprising a data controller, wherein the data controller saved data that cannot be changed.

7. The mechanism to incent taxpayers of claim 1, comprising a tax receiving agency, wherein said aggregator provides transactional information to the tax receiving agency.

8. The mechanism to incent taxpayers of claim 7, wherein said tax receiving agency is a government agency.

9. The mechanism to incent taxpayers of claim 1, comprising a and informative file and a detailed deposit file, wherein said informative file include the daily transactional information; and wherein said detailed deposit file include previously recorded transactional information deposited into a merchant account.

10. The mechanism to incent taxpayers of claim 9, wherein the aggregator received and process the informative file and the detailed deposit file on daily basis.
